(19) United States
(12) Patent Application Publication
(10) Pub. No.: US 2014/0026699 A1
(43) Pub. Date: Jan. 30, 2014

(54) COUPLING DEVICE WITH A GEARSHIFT SLEEVE FOR A GEARSHIFT TRANSMISSION

(71) Applicant: GM GLOBAL TECHNOLOGY OPERATIONS LLC, Detroit, MI (US)

(72) Inventor: Christian KUNZE, Gross-Gerau (DE)

(73) Assignee: GM GLOBAL TECHNOLOGY OPERATIONS LLC, Detroit, MI (US)

(21) Appl. No.: 13/951,790

(22) Filed: Jul. 26, 2013

(30) Foreign Application Priority Data
Jul. 28, 2012 (DE) 10 2012 015 006.7

(51) Int. Cl. F16D 11/14

(52) U.S. Cl. CPC F16D 11/14
USPC 74/373

(57) ABSTRACT

A coupling device is provided with a gearshift sleeve for a gearshift transmission. The gearshift sleeve via a first inner toothing optionally couples a first or second coupling gear rim of a first or second toothed gear wheel to an outer toothing of a hub body. The gearshift sleeve comprises a second inner toothing, with which the gearshift sleeve can be brought into engagement with the second coupling gear rim of the second toothed gear wheel and simultaneously via the first inner toothing with the first coupling gear rim of the first toothed gear wheel subject to freewheeling of the hub body.

### CROSS-REFERENCE TO RELATED APPLICATION

This application claims priority to German Patent Application No. 10 2012 015 006.7, filed Jul. 28, 2012, which is incorporated herein by reference in its entirety.

### TECHNICAL FIELD

The technical field generally relates to a coupling device with a gearshift sleeve for a gearshift transmission.

### BACKGROUND

From the publication U.S. Pat. No. 4,809,832 a gear synchronization mechanism is known that comprises a toothed gear wheel, which is rotatably arranged on a shaft. This mechanism additionally comprises a cylindrical hub body that is arranged on the shaft in a rotationally fixed manner. A gearshift sleeve has a spur toothing on its inner side, which is in constant engagement with an outer spur toothing of the hub body. The gearshift sleeve can be axially shifted on the hub body and can be brought into engagement with a coupling gear rim of the toothed gear wheel via a synchronization device. With such a known coupling device it is possible to couple a first toothed gear wheel to the hub body or a second toothed gear wheel to the same gearshift sleeve to the hub body and thus to the gearshift transmission shaft.

In view of the foregoing, at least one object is to create a coupling device with a gearshift sleeve for a gearshift transmission, which makes available further gearshift transmission variations. In addition, other objects, desirable features and characteristics will become apparent from the subsequent summary and detailed description, and the appended claims, taken in conjunction with the accompanying drawings and this background.

### SUMMARY

In a first embodiment, a coupling device is created with a gearshift sleeve for a gearshift transmission. Via a first inner toothing, the gearshift sleeve optionally couples a first or second coupling gear rim of a first or second toothed gear wheel to an outer toothing of a hub body. The gearshift sleeve has a second inner toothing, with which the gearshift sleeve can be brought into engagement with the second coupling gear rim of the second toothed gear wheel and simultaneously with the first coupling gear rim of the first toothed gear wheel via the first inner toothing subject to freewheeling of the hub body.

This coupling device has the advantage that it makes available further gearshift transmission variations, without increasing the number of toothed gear wheels. Merely the gearshift sleeve is axially extended in its axial extension by the width of the outer toothing of the hub body in order to create the possibility that the hub body runs freely while the coupling gear rims of the two toothed gear wheels are in engagement with the gearshift sleeve. Such a combination of gearshift sleeve and toothed gear wheels presupposes that the toothed gear wheels do not mesh with gears arranged in a rotationally fixed manner such as for example conventional drive gears of a drive shaft. The new coupling device is employable in an advantageous manner for an automatic gearshift transmission, in which the predominant parts of the inter-meshing gears interact with this new coupling device. Particularly advantageously, this new coupling device can be employed in automatic gearshift transmissions, which have three or more gearshift transmission shafts.

In a further embodiment, the first toothed gear wheel comprises the first coupling gear rim and is rotatably mounted on a gearshift transmission shaft. Correspondingly, the second toothed gear wheel is equipped with the second coupling gear rim and is likewise rotatably mounted on the gearshift transmission shaft. The hub body, by contrast, is fixed on the gearshift transmission shaft in a rotationally fixed and axially fixed manner and has a straight outer toothing. The gearshift sleeve, with its first inner toothing and its second inner toothing that is spaced from the first inner toothing can be positioned in an axially displaceable manner in four axial positions between the first and second coupling gear rims.

Here, in a first neutral axial position of the gearshift sleeve, the first inner toothing is in engagement with the outer toothing of the hub body subject to freewheeling of the two toothed gear wheels. In a second axial position of the gearshift sleeve, the first inner toothing is in engagement with the outer toothing of the hub body and with the first coupling gear rim subject to freewheeling of the second toothed gear wheel. In a third axial position of the gearshift sleeve, the first inner toothing is in engagement with the outer toothing of the hub body and the second coupling gear rim subject to freewheeling of the first toothed gear wheel. Finally, in a fourth axial position of the gearshift sleeve, the first inner toothing is in engagement with the coupling gear rim of the first toothed gear wheel and the second inner toothing with the second coupling gear rim of the second toothed gear wheel subject to freewheeling of the hub body. With these four axial positions of the gearshift sleeve with two inner toothings spaced from one another the possibility of the combinable gearshift transmission ratios in a gearshift transmission, in particular in an automatic gearshift transmission, is now expanded fundamentally. Here, the width of the inner toothings of the gearshift sleeve of the outer toothing of the hub body and the spacing between the two inner toothings of the gearshift sleeve has to be matched to one another so that these four shifting positions of the gearshift sleeve can be realized.

In a further embodiment, a spacing in axial direction between the first and the second inner toothing of the gearshift sleeve is therefore greater than the width of the outer toothings of the hub body. By doing so it is ensured that the hub body can run freely in the region between the two inner toothings of the gearshift sleeve.

It is provided, furthermore, that the width of the first inner toothing in axial direction is greater than or equal to the width of the outer toothing of the hub body. The width of the first inner toothing of the gearshift sleeve has to ensure that in the second axial position the first inner toothing is in engagement with the outer toothing of the hub body and with the coupling gear rim of the first toothed gear wheel. Furthermore, the width of the second inner toothing in axial direction in a further embodiment corresponds to at least the width of the second coupling gear rim.

In a further embodiment, the width of the gearshift sleeve in axial direction corresponds to at least the sum of double the width of the outer toothing of the hub body and double the width of the second coupling gear rim. Such a gearshift sleeve accordingly has a significantly increased length compared with conventional gearshift sleeves.

The coupling device can additionally comprise synchronization devices with at least one synchronizing ring each. The synchronizing ring has a conical coupling surface and an outer gear rim. The synchronization devices are arranged on one side to the first coupling gear rim and on both sides to the second coupling gear rim.

In order to ensure synchronization in the three shifting positions of the gearshift sleeve, the coupling device comprises at least three synchronization devices in a further embodiment with at least one synchronizing ring each, which has a conical coupling surface and an outer gear rim, also called locking gear rim. Here, a first such synchronizing ring is aligned on one side to the first coupling gear rim while two further synchronizing rings are arranged on both sides of the second coupling gear rim. On both sides or on both the sides in this context means that a synchronizing ring is arranged left or the second coupling gear rim and a further synchronizing ring is positioned right of the second coupling gear rim.

A further embodiment relates to a gearshift transmission, which comprises a coupling device according to any one of the preceding embodiments. The gearshift sleeve can be optionally brought into engagement in four axial positions with an outer toothing of a hub body and/or with coupling gear rims of toothed gear wheels.

In addition, a further embodiment relates to a motor vehicle with a corresponding gearshift transmission. Preferentially such a gearshift transmission is automatically actuated as a function of a drive moment loading.

### BRIEF DESCRIPTION OF THE DRAWINGS

The present invention will hereinafter be described in conjunction with the following drawing figures, wherein like numerals denote like elements, and:

FIG. 1 shows a schematic diagram of a coupling device according to an embodiment with a gearshift sleeve in a first neutral axial position;

FIG. 2 shows a schematic diagram of the coupling device according to FIG. 1 with the gearshift sleeve in a second axial position;

FIG. 3 shows a schematic diagram of the coupling device according to FIG. 1 with the gearshift sleeve in a third axial position;

FIG. 4 shows a schematic diagram of the coupling device according to FIG. 1 with the gearshift sleeve in a fourth axial position;

FIG. 5 shows a schematic diagram of the coupling device according to FIG. 1 with the gearshift sleeve in the neutral first axial position and with three synchronization devices;

FIG. 6 shows a schematic diagram of the coupling device according to FIG. 5 with the gearshift sleeve in an axial transition position to the second axial position;

FIG. 7 shows a schematic diagram of the coupling device according to FIG. 5 with the gearshift sleeve in the second axial position;

FIG. 8 shows a schematic diagram of the coupling device according to FIG. 5 with the gearshift sleeve in a transition position to the third axial position;

FIG. 9 shows a schematic diagram of the coupling device according to FIG. 5 with the gearshift sleeve in the third axial position;

FIG. 10 shows a schematic diagram of the coupling device according to FIG. 5 with the gearshift sleeve in a transition position to the fourth axial position; and

FIG. 11 shows a schematic diagram of the coupling device according to FIG. 5 with the gearshift sleeve in the fourth axial position.

### DETAILED DESCRIPTION

The following detailed description is merely exemplary in nature and is not intended to limit application and uses. Furthermore, there is no intention to be bound by any theory presented in the preceding background or summary or the following detailed description.

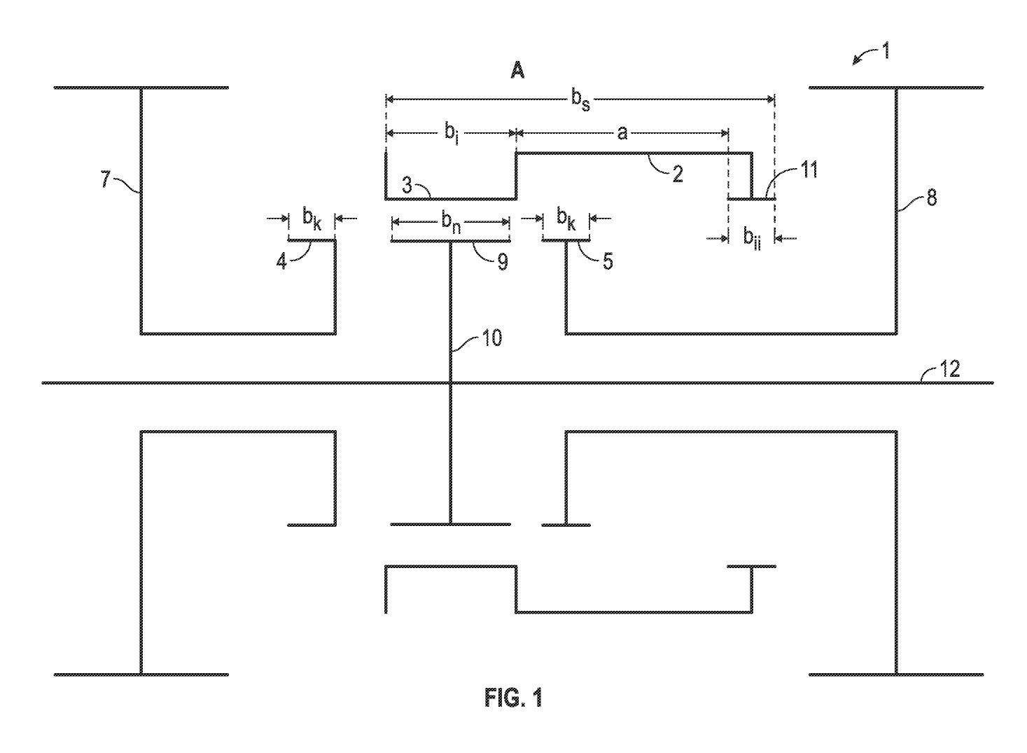

FIG. 1 shows a schematic diagram of a coupling device 1 according to an embodiment with a gearshift sleeve 2 in a first neutral axial position A between a first toothed gear wheel 7 and a second toothed gear wheel 8, which are rotatably arranged on a gearshift transmission shaft 12. Between the toothed gear wheels 7 and 8 a hub body 10 with an outer tooting 9 of a width Bn is arranged on the gearshift transmission shaft 12 in a rotationally fixed manner.

In this first neutral position A of the gearshift sleeve 2, the outer toothing 9 of the hub body 10, which is connected to the gearshift transmission shaft 12 in a rotationally fixed manner, is in engagement with a first inner toothing 3 of the gearshift sleeve 2. The first inner toothing 3 has a width bi, which corresponds to the width of the outer toothing bn. Additionally, the gearshift sleeve 2 has a second inner toothing 11 of a width bii, which are arranged a distance a away from the first inner toothing 3. In this first axial neutral position A of the gearshift sleeve 2, the first inner toothing 3 meshes with the outer toothing 9 of the hub body 10.

The first toothed gear wheel 7 comprises a coupling gear rim 4, which in this position A of the gearshift sleeve 2 is not in engagement with one of the inner toothings of the gearshift sleeve 2, so that the first toothed gear wheel 7 is arranged on the gearshift transmission shaft 12 in a freely running manner. The same applies to the second toothed gear wheel 8, whose coupling gear rim 5 with the width bk is likewise not in connection with one of the inner toothings 3 or 11 of the gearshift sleeve 2 in this neutral axial position A. Thus, the second toothed gear wheel 8 is also arranged on the gearshift transmission shaft 12 in a freely running manner.

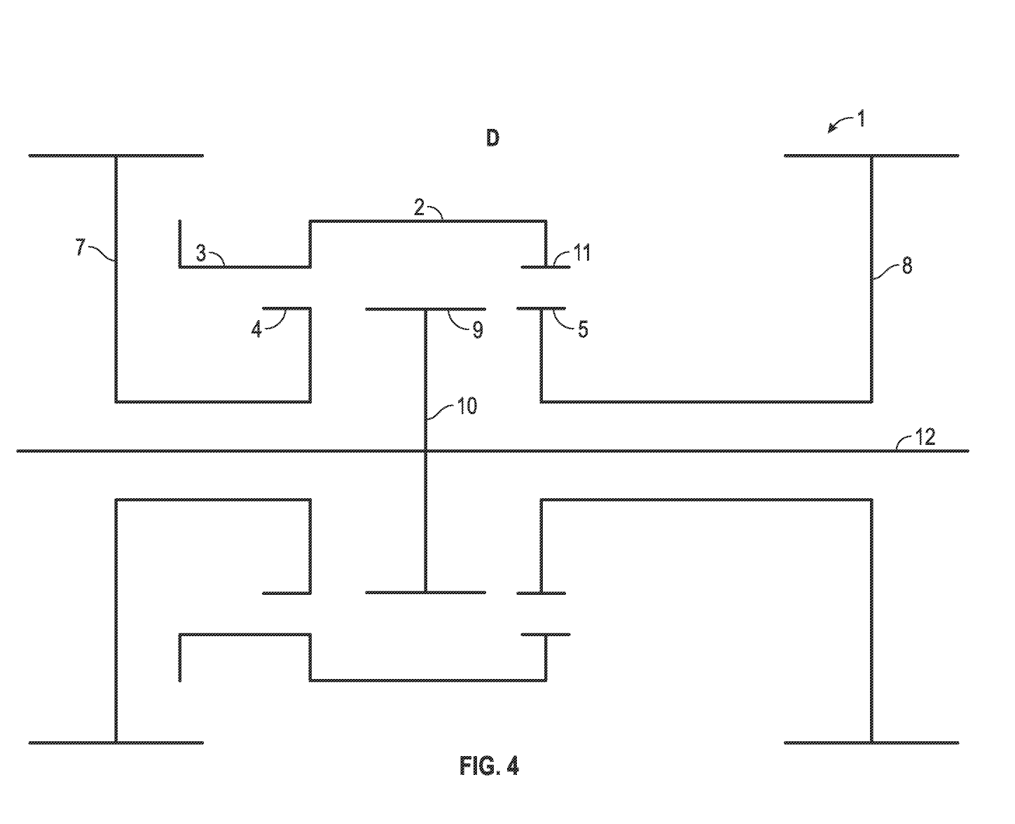

The distance a between the two inner toothings 3 and 11 of the gearshift sleeve 2 is dimensioned such that the two inner toothings 3 and 11 of the gearshift sleeve 2 can mesh with the two coupling gear rims 4 and 5 of the toothed gear wheels 7 and 8, without the inner toothing of the gearshift sleeve being in engagement with the outer toothings 9 of the hub body 10, so that in a fourth position D of the gearshift sleeve 2, as is shown in FIG. 4, the hub body 10 can run freely. This results in that the width bs of the gearshift sleeve 2 in axial direction has to be greater than double the width of the outer toothing 9 of the hub body 10 and additionally of double a width bii of the second inner toothing 11. Here, the width bii corresponds to at least the width bk of the second coupling gear rim of the second gear wheel 8.

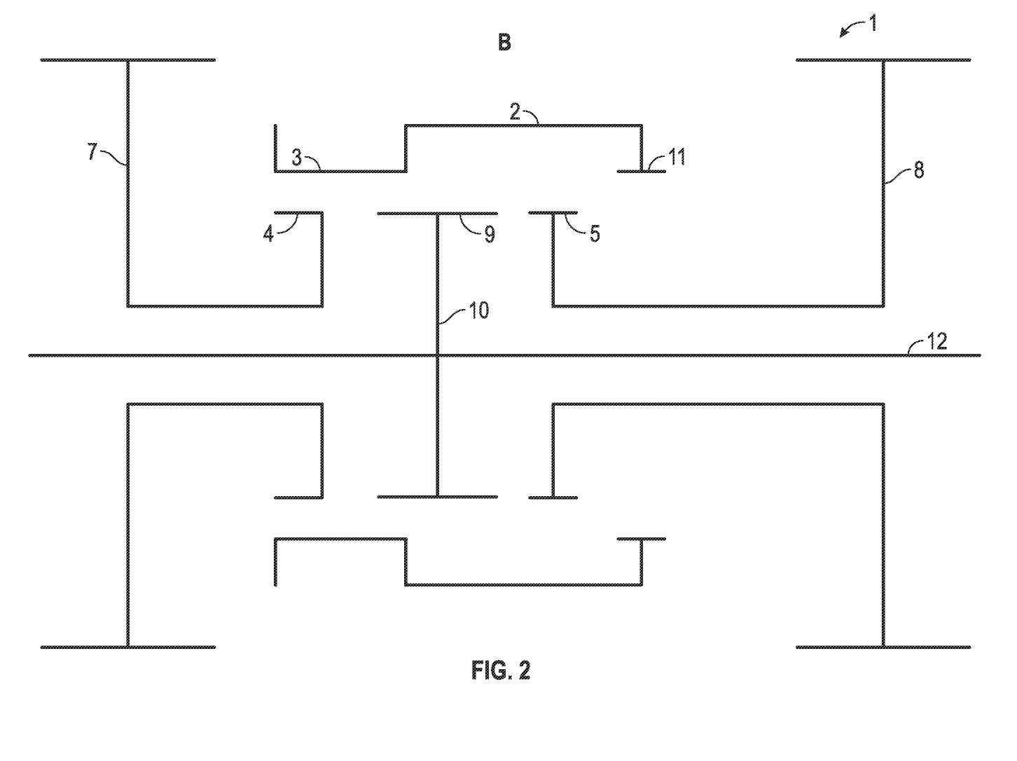

FIG. 2 shows a schematic diagram of the coupling device 1 according to FIG. 1 with the gearshift sleeve 2 in a second axial position B. In this second axial position B, the first inner toothing 3 of the gearshift sleeve 2 meshes with the outer toothing 9 of the hub body 10 and simultaneously with the first coupling gear rim 4 of the first toothed gear wheel 7, so that the toothed gear wheel 7 via the coupling gear rim 4, the first inner toothing 3 of the gearshift sleeve 2 and via the outer toothing 9 of the hub body 10 is now connected to the gearshift transmission shaft 12 in a rotationally fixed manner. In this second axial position B of the gearshift sleeve 2, the second toothed gear wheel 8 is now freewheeling.

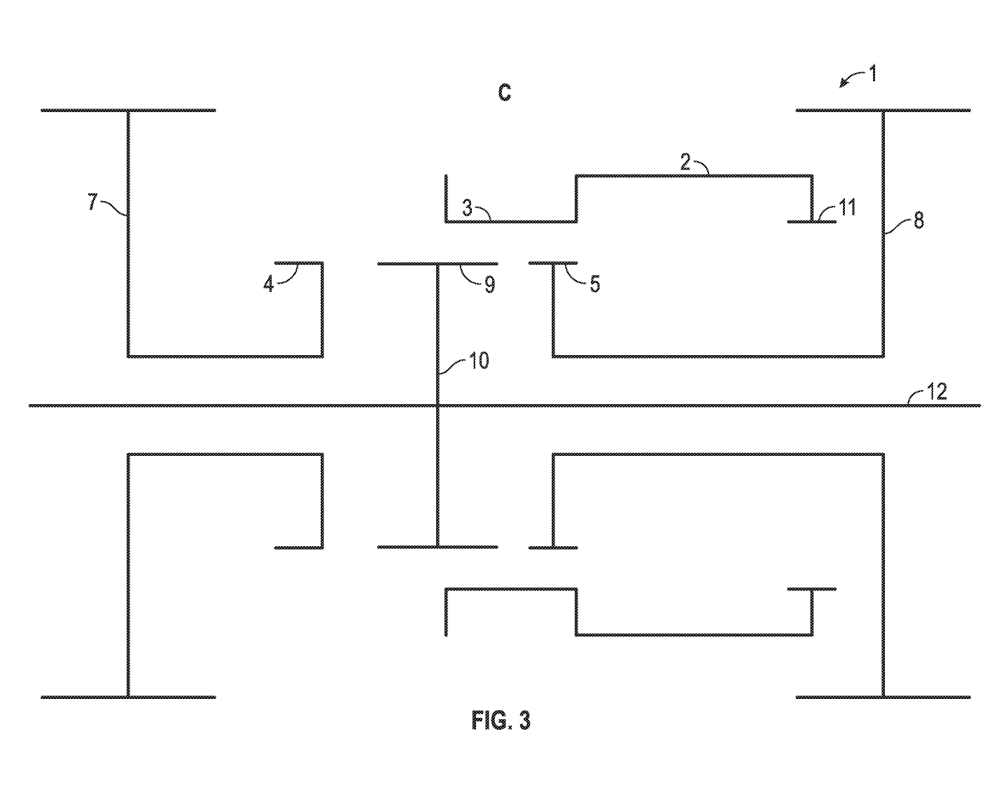

FIG. 3 shows a schematic diagram of the coupling device 1 according to FIG. 1 with the gearshift sleeve 2 in a third axial position C. In this axial position C the inner toothing 3 of the gearshift sleeve 2 meshes both with the inner toothing 9 of the hub body 10 as well as with the second coupling gear rim 5 of the second toothed gear wheel 8, so that in this third axial position C of the gearshift sleeve 2 the first toothed gear wheel 7 runs freely, while the second toothed gear wheel 8 is now connected to the gearshift transmission shaft 12 in a rotationally fixed manner via the second coupling gear rim 5, the first inner toothing 3 of the gearshift sleeve 2 and the outer toothing 9 of the hub body 10.

FIG. 4 shows a schematic diagram of the coupling device 1 according to FIG. 1 with a gearshift sleeve 2 in a fourth axial position D, in which the first inner toothing 3 of the gearshift sleeve 2 now meshes with the first coupling gear rim 4 of the first toothed gear wheel 7 and a second inner toothing 11 of the gearshift sleeve 2 is simultaneously in engagement with the second coupling gear rim 5 of the second toothed gear wheel 8. While the hub body 10 with the outer toothing 9 runs freely, both toothed gear wheels 7 and 8 are coupled and are not in connection with the gearshift transmission shaft 12. In this configuration, the toothed gear wheels 7 and 8 can be in engagement with further gears, which can be coupled in a similar manner to a gearshift transmission shaft, be it a driveshaft or an output shaft.

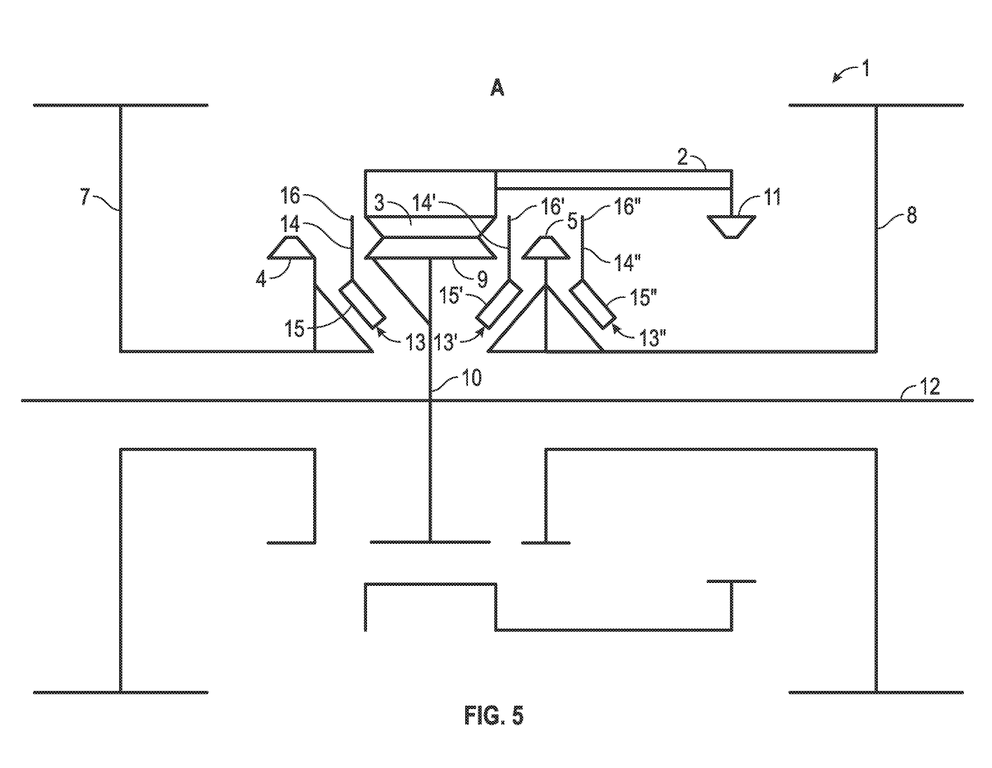

The following FIG. 5 to FIG. 11 additionally show the interaction of the gearshift sleeve 2 with three synchronization devices in order to make possible a synchronized transition between the individual axial positions, as shown in the FIG. 1 to FIG. 4.

FIG. 5 shows a schematic diagram of the coupling device 1 according to FIG. 1 with the gearshift sleeve 2 in the neutral first axial position A and with three synchronization devices 13, 13′ and 13″ in order to make possible a synchronous shifting of the gearshift sleeve 2 into the further three axial positions B, C and D. To this end, a first synchronization device 13 to the first toothed gear wheel 7 for a synchronized transition of the gearshift sleeve 2 into the second axial position B is provided.

Furthermore, a second synchronization device 13′ is provided on a side of the coupling gear rim 5 of the toothed gear wheel 8 in order to make possible a synchronized transition of the gearshift sleeve 2 into the third axial position C. Finally, on a side opposite the second synchronization device 13′ on the coupling gear rim 5 a third synchronization device 13″ is provided, which in interaction with a third synchronization device 13″ make possible a synchronous transition of the gearshift sleeve 2 into the fourth axial position. In this neutral axial position A of the gearshift sleeve 2 shown in FIG. 5, none of the synchronization devices 13, 13′ or 13″ is active so that the synchronizing rings 14 with their conical coupling surfaces 15, 15′ and 15″ and their outer gear rims 16, 16′ and 16″ can run freely.

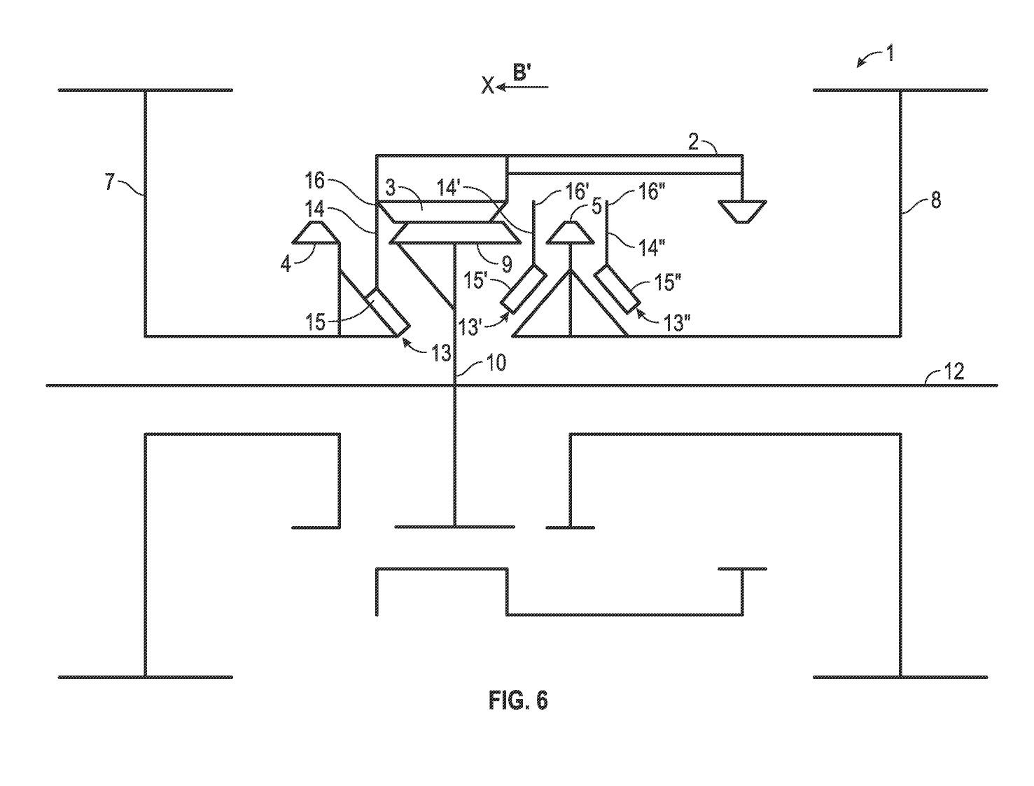

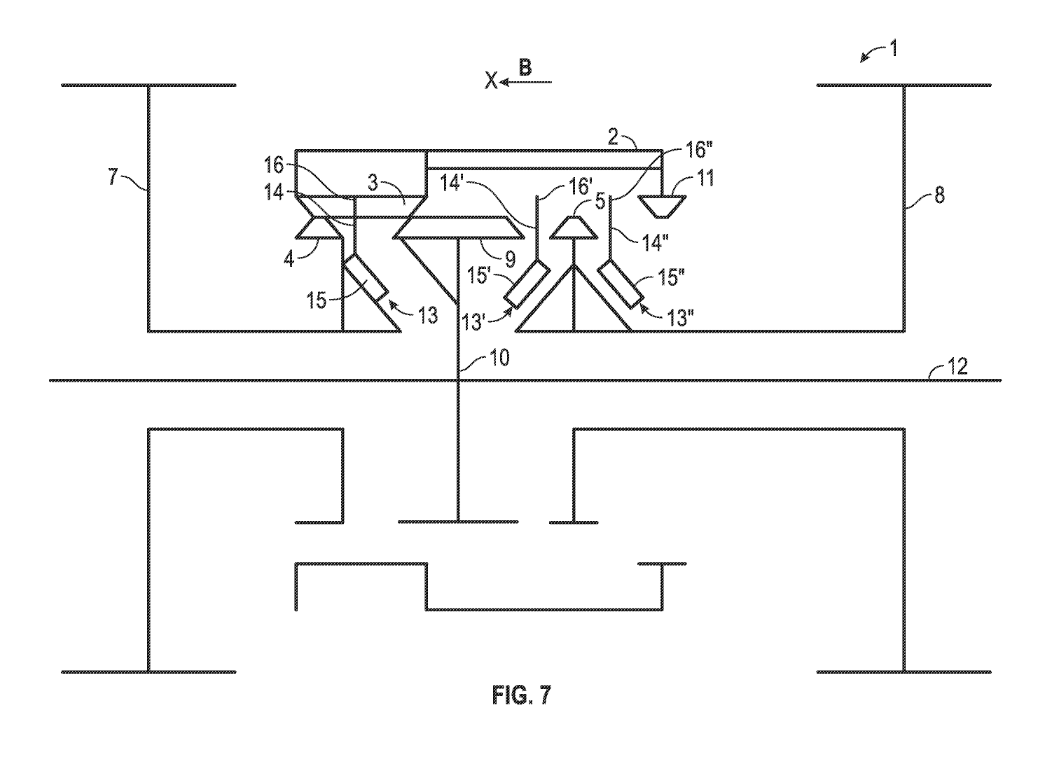

FIG. 6 shows a schematic diagram of the coupling device 1 according to FIG. 5 with the gearshift sleeve 2 in an axial transition position B′ to the second axial position B. To this end, the gearshift sleeve 2 is shifted in axial direction X to the synchronizing ring 14, which with the coupling surface 15 is in frictional connection with the help of the toothed gear wheel 7, so that upon synchronization between toothed gear wheel 7 and gearshift sleeve 2 the first inner toothing 3 of the gearshift sleeve 2 can be brought into engagement with the coupling gear rim 4 of the first toothed gear wheel 7 subject to overcoming the locking gear rim 16 of the synchronizing ring 14, as is shown by the next FIG. 7.

FIG. 7 shows a schematic diagram of the coupling device 1 according to FIG. 5 with the gearshift sleeve 2 in the second axial position B. The gearshift sleeve 2 with its first inner toothing 3 is in engagement with the outer toothing 9 of the hub body 10 and simultaneously with the first coupling gear rim 4 of the first toothed gear wheel 7, while the second toothed gear wheel 8 can run freely.

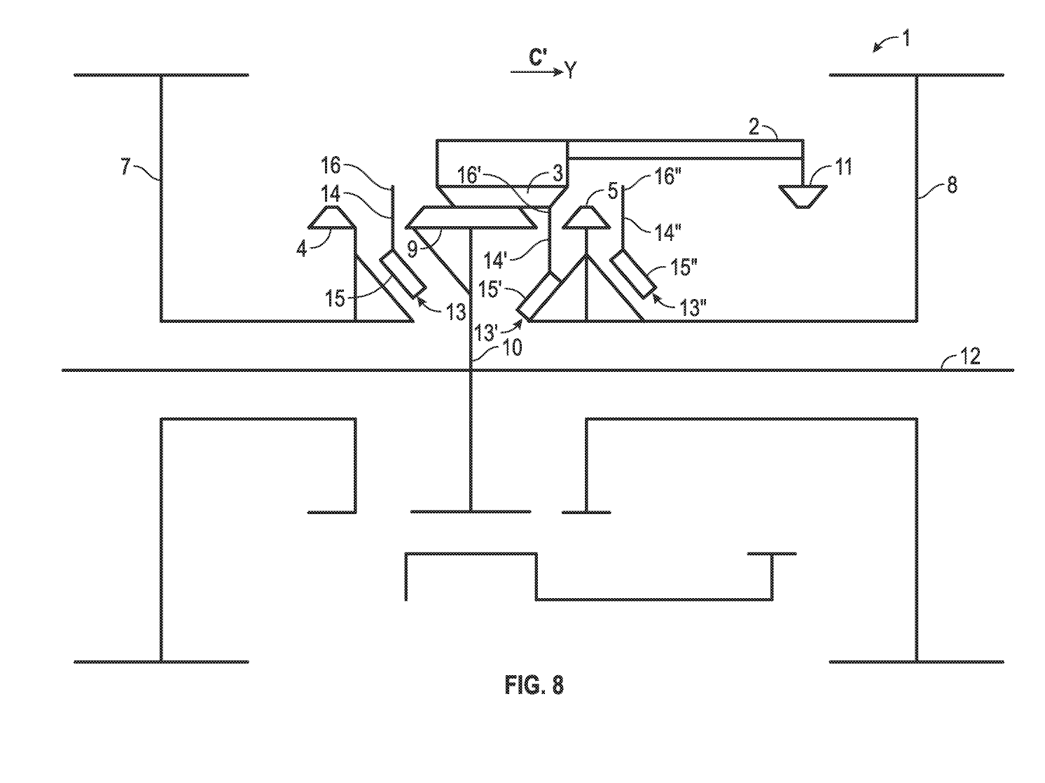

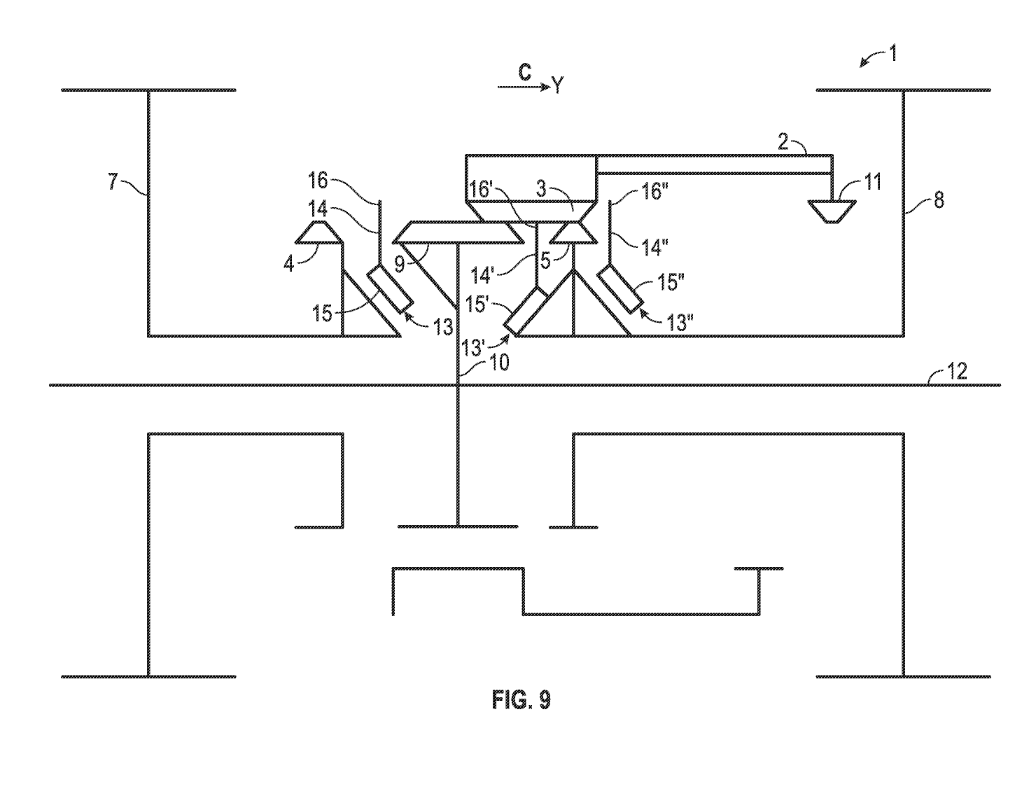

FIG. 8 shows a schematic diagram of the coupling device 1 according to FIG. 5 with the gearshift sleeve 2 in an axial transition position C′ to the third axial position. The gearshift sleeve 2 is axially shifted in arrow direction Y. Here, a frictional connection of the coupling surface 15′ of the second synchronizing ring 14′ is formed, with which the second toothed gear wheel 8 is accelerated so that upon synchronization of the toothed gear wheel 8 and the gearshift sleeve 2 the first inner toothing 3 of the gearshift sleeve 2 via the outer or locking gear rim 16′ of the second synchronizing ring 14′ can be axially brought to enter the coupling gear rim 5 of the second toothed gear wheel 8, as shown in FIG. 9.

FIG. 9 shows a schematic diagram of the coupling device 1 according to FIG. 5 with the gearshift sleeve 2 in the third axial position C. In this position C, the inner toothing 3 or the gearshift sleeve 2 meshes with the outer toothing 9 of the hub body 10 and simultaneously with the coupling gear rim 5 of the second toothed gear wheel 8, so that said inner toothing 3 via the gearshift sleeve 2 and the hub body 10 is connected to the gearshift transmission axis in a rotationally fixed manner while the first toothed gear wheel 7 runs freely.

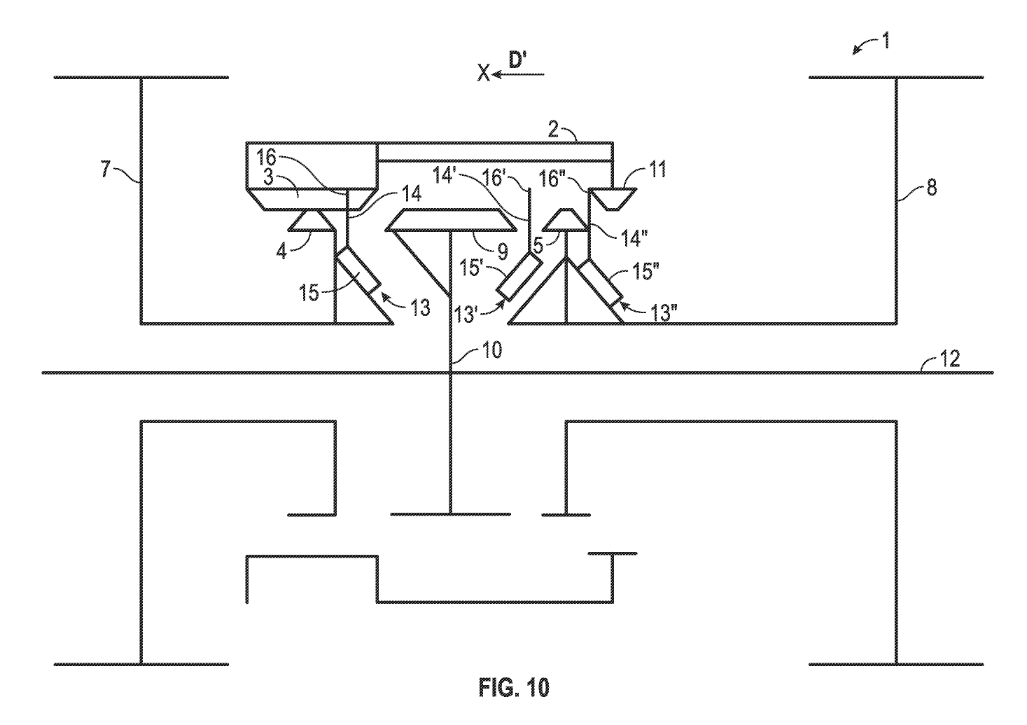

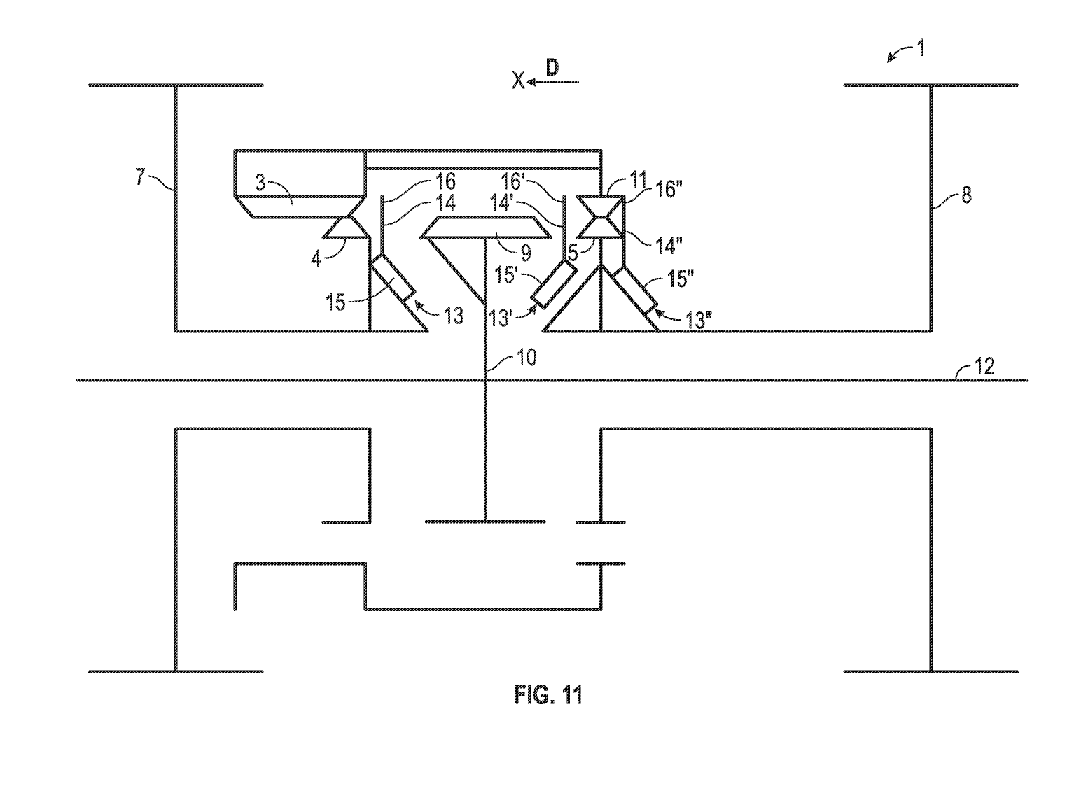

FIG. 10 shows a schematic diagram of the coupling device 1 according to FIG. 5 with the gearshift sleeve 2 in a transition position D′ to the fourth axial position D. The gearshift sleeve 2 to this end is shifted in axial direction in the direction X and the second inner toothing 11 of the gearshift sleeve 2 is in frictional connection with its conical coupling surface with the hub of the second toothed gear wheel 8, so that the second toothed gear wheel 8 can be brought into synchronization with the first toothed gear wheel 7, which is already in engagement with the first inner toothing 3 of the gearshift sleeve 2 via the first coupling gear rim 4 of the first toothed gear wheel 7. As soon as synchronization between the two toothed gear wheels 7 and 8 is reached, indexing of the outer gear rim 16″ of the synchronization device 13″ with the coupling gear rim 5 of the second toothed gear wheel 8 can take place and the gearshift sleeve 2 be brought in its fourth axial position D, as shown by FIG. 11.

FIG. 11 shows a schematic diagram of the coupling device 1 according to FIG. 5 with the gearshift sleeve 2 in the fourth axial position D, in which the two toothed gear wheels 7 and 8 are now coupled and rotatably mounted on the gearshift transmission shaft 12, while the outer toothing 9 of the hub body 10 is not in engagement with any of the inner toothings 3 or 11 of the gearshift sleeve 2, so that the hub body 10 can freely rotate with the gearshift transmission shaft 12, independently of the toothed gear wheels 7 and 8.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A coupling device with a gearshift sleeve for a gearshift transmission, comprising:
a first inner toothing coupling a first coupling gear rim of a first toothed gear wheel to an outer toothing of a hub body; and
a second inner toothing with which the gearshift sleeve is brought into engagement with a second coupling gear rim of a second toothed gear wheel and via the first inner toothing with the first coupling gear rim of the first toothed gear wheel, subject to a freewheeling of the hub body.

2. The coupling device according to claim 1, wherein the first toothed gear wheel is rotatably mounted on a gearshift transmission shaft and comprises the first coupling gear rim.

3. The coupling device according to claim 1,
wherein in a neutral first axial position of the gearshift sleeve the first inner toothing is in engagement with the outer toothing of the hub body subject to freewheeling of the first toothed gear wheel and the second toothed gears.

4. The coupling device according to claim 1, wherein a distance in an axial direction between the first inner toothing and the second inner toothing of the gearshift sleeve is greater than a width (bn) of the outer toothing of the hub body.

5. The coupling device according to claim 4, wherein a width (bi) of the first inner toothing in the axial direction is greater than or equal to the width (bn) of the outer toothing of the hub body.

6. The coupling device according to claim 1, wherein a width (bii) of the second inner toothing in an axial direction corresponds to at least a width (bk) of the second coupling gear rim.

7. The coupling device according to claim 1, wherein the gearshift sleeve has a width (bs) in an axial direction that corresponds at least to a sum of double a width (2 bn) of the outer toothing of the hub body and double a width (2 bii) of the second coupling gear rim.

8. The coupling device according to claim 1, wherein synchronization devices each with at least one synchronizing ring, which comprises a conical coupling surface and an outer gear rim, are arranged on one side to the first coupling gear rim and on both sides to the second coupling gear rim.

9. (canceled)

10. (canceled)

11. The coupling device according to claim 2, wherein in a second axial position of the gearshift sleeve the first inner toothing is in engagement with the outer toothing of the hub body and the first coupling gear rim subject to freewheeling of the second toothed gear wheel.

12. The coupling device according to claim 11, wherein in a further axial position of the gearshift sleeve the first inner toothing is in engagement with the outer toothing of the hub body and the second coupling gear rim subject to freewheeling of the first toothed gear wheel.

13. The coupling device according to claim 12, wherein in a fourth axial position of the gearshift sleeve the first inner toothing is in engagement with the first coupling gear rim of the first toothed gear wheel and the second inner toothing with the second coupling gear rim of the second toothed gear wheel subject to freewheeling of the hub body.

14. The coupling device according to claim 3, wherein in a second axial position of the gearshift sleeve the first inner toothing is in engagement with the outer toothing of the hub body and the first coupling gear rim subject to freewheeling of the second toothed gear wheel.

15. The coupling device according to claim 14, wherein in a further axial position of the gearshift sleeve the first inner toothing is in engagement with the outer toothing of the hub body and the second coupling gear rim subject to freewheeling of the first toothed gear wheel.

16. The coupling device according to claim 15, wherein in a fourth axial position of the gearshift sleeve the first inner toothing is in engagement with the first coupling gear rim of the first toothed gear wheel and the second inner toothing with the second coupling gear rim of the second toothed gear wheel subject to freewheeling of the hub body.
